(19) United States
(12) Patent Application Publication
(10) Pub. No.: US 2010/0221686 A1
(43) Pub. Date: Sep. 2, 2010

(54) Educational board game

(76) Inventor: Lanita Kay Johnson, Spanaway, WA (US)

Correspondence Address: Kevin Steinacker, Ste 1401, 1201 Pacific Ave, Tacoma, WA, 98402, US

(21) Appl. No.: 12/660,573

(22) Filed: Mar. 1, 2010

Related U.S. Application Data
(60) Provisional application No. 61/208,742, filed on Feb. 27, 2009.

(51) Int. Cl. G09B 19/22; A63F 3/00

(52) U.S. Cl. 434/129; 273/243

(57) ABSTRACT

An educational board game includes a board depicting a track with a plurality of spaces sized to accept player position tokens and a card set for each player containing questions or tasks designed to test the player's knowledge, with each player's card set differing based on the quantity of cards, the difficulty level, and/or the subject matter. Movement of the position tokens is determined by a random number generator. Some of the spaces on the track are designated draw spaces, directing the player to draw a card from the card set and attempt to give the correct response. A player may win the game by correctly responding to all cards in the card set. The variation between each player's card set allows players of differing skill levels to play at the same time.

### PRIORITY

The applicant claims priority from a Provisional Patent Application filed on Feb. 27, 2009, under Application No. 61/208,742.

### FIELD OF THE INVENTION

The present invention generally relates to board games and to educational board games in particular.

### BACKGROUND OF THE INVENTION

Board games of many descriptions are known in the prior art. Some board games are designed particularly to educate while entertaining the learner. However, no board game currently exists that allows for customization of the educational game aspect to each individual player's educational needs and goals. Further, many educational board games do not lend themselves to entertaining play by players of varying knowledge or ability

Thus, there is a need for an educational board game that can be customized to each player's educational needs and goals and that may be enjoyed simultaneously by players of varying knowledge or ability. The present invention fulfills this and other needs.

### SUMMARY OF THE INVENTION

An object of the present invention, which will be described subsequently in greater detail, is to provide an educational board game that can be customized to each player's educational needs and goals and that may be enjoyed simultaneously by players of varying knowledge or ability.

An educational board game is provided that includes a plurality of card sets and a board depicting a track with a plurality of spaces along which each player moves a position token. The spaces are sized to accept at least one of the tokens.

Preferably, one card set is used for each player during a round of play. Each player's card set is compiled prior to play according to that particular player's educational needs and/or goals. Both the number of cards in a set, and the difficulty and subject matter of the cards, may vary between the players. The card sets are preferably compiled such that the relative difficulty for each player is approximately equal, or so that each player has a chance to successfully provide responses to all the cards in his or her card set in approximately the same amount of time.

For example, a first player's card set may be comprised of cards requiring letter recognition, a second player's card set may be comprised of cards requiring reading of simple words, and a third player's card set may be comprised of cards requiring the player to state the definition of complex words. As another example, a first player's card set may be comprised of cards requiring the player to count objects on the card, a second player's card set may be comprised of cards requiring the player to answer simple arithmetic problems, and a third player's card set may be comprised of cards requiring the player to solve more advanced mathematical equations. The variation between the card sets of each player allows players of varying ability or educational levels to enjoy the game together.

In the preferred embodiment, a back side of each card in a card set is comprised of a top section containing a question or task designed to test the player's knowledge, and a bottom section containing instructions to the player. The top section may have a general question common to many cards and a specific item related to the general question. Examples of content for the top section are collected in the following table:

| General question | Specific item |
|---|---|
| What word is this? | Any word to be read by the player, or an ASL hand sign to be |
| | identified by the player. |
| What number is this? | Any numeral to be identified by the player. |
| What letter is this? | Any letter to be identified by the player, or an ASL hand sign to be |
| | identified by the player. |
| What is the solution? | Any mathematical equation to be solved by the player. |
| What is the shape? | Any shape to be identified by the player. |
| What is the color? | An object of any color to be identified by the player. |
| What is it? | A picture of an object or animal to be identified by the player. Can be |
| | used for young players or for players learning a foreign language. |
| What does it mean? | Any word for the player to define. |
| What time is it? | A clock face depicting a time for the player to identify. |
| Match the time. | A blank analog clock face and a digital clock face displaying a time. |
| | The player's object is to draw the correct clock hands on the analog |
| | clock. |
| How much is this? | Images of different coins or currency along with an indication of how |
| | many of each type are to be considered. The player's object is to state |
| | the total of all the money depicted. |
| How many? | Any number of objects for the player to count. |
| Answer the question. | Any question for the player to answer. |

In the bottom section, each card has a set of instructions to the player to be followed if the player provides the correct response, and a set of instructions to be followed if the incorrect response is given. The correct response instructions are preferably placed next to a symbolic representation of a happy face. The correct response instructions could include “move ahead (a specified number) of spaces, an encouraging phrase such as “good job,” and/or instructions unrelated to game play such as “clap your hands” or “hug another player.” The incorrect response instructions are preferably placed next to a symbolic representation of a sad face, and direct the player to discard the card.

In one embodiment, a card set contains a series subset, comprised of a plurality of series cards identified by a unique symbol so that cards of one series subset may be distinguished from cards of another series subset in the same card set. The instructions for a correct response on a series card instruct the player to “keep the card” ” or “keep it.” The series cards of each series subset are to be placed in proper sequential order by the player as the game progresses. For example, words may be put together to form a sentence, letters may be placed in alphabetical order, or numerals may be placed in numerical order.

In one embodiment, all or part of the top section of one or more cards in a card set is customizable by the player or a supervising adult prior to beginning play. A customizable card has an erasable surface and one or more blanks to be filled in. For example, cards containing “What word is this?” or “What does it mean?” in the top section can be filled in with words the player is learning at the time the game is played, erased after play, and a new set of words filled in for the next session. In another embodiment, the bottom sections of a card or cards in a card set may also be customizable. Preferably, the customizable portions of any cards would be filled out prior to play according to current homework assignments or feedback from the player's teacher on progress reports. In yet another embodiment, card sets corresponding to varying subjects and levels of difficulty are pre-printed and may be used interchangeably according to the desires of individual players.

As mentioned, the board depicts a track comprising a plurality of separate spaces. The track has at least one space that is designated as a starting space. In the preferred embodiment, there is a separate designated starting space for each player.

A position token representing each player is placed on the designated starting space on the track. Each player's card set is placed to form a draw pile. Preferably, the board designates a location for the draw pile for each player. On each player's turn, the player moves his or her position token a number of spaces along the track according to a random number generator (such as a die). Some spaces have an instruction associated with them. The player follows the instruction, if any, associated with the space where the player's token landed.

The track has at least one space that instructs a player to draw one or more cards from the player's card set. Other spaces on the track may have other instructions, such as directing a player to lose a turn or to move a specified number of spaces forward or backward along the track. The instructions may not be directly printed on the space, but in some embodiments, spaces on the track have a unique instruction symbol that corresponds to certain instructions as indicated in a game manual. In the preferred embodiment the spaces on the track are not pre-printed with instructions or symbols, but the players customize the track prior to beginning play by placing removable stickers depicting the instruction symbols indicated in the game manual onto at least some of the spaces on the track.

In the preferred embodiment, when any player's token ends its move on a space with a first instruction symbol (such as a star), the player is instructed to draw one card from the player's card set. In the preferred embodiment, each player chooses a unique second instruction symbol prior to play. During game play, when a player's token ends its move on a space with that player's second instruction symbol, the player is instructed to draw two cards from the player's card set. During game play, when a player's token ends its move on a space with another player's second instruction symbol, the player is instructed to move back a specified number of spaces.

When a player's token lands on a space associated with the instruction to draw a card, the player takes the top card from that player's draw pile. If the player gives the correct response, the player follows the instructions on the card for giving the correct response. Unless otherwise directed, the card is then placed in a stack with all previously correctly answered cards, which is designated on the board with the symbolic representation of a happy face in the preferred embodiment. If the player gives the incorrect response, the card is placed in a stack with all previously incorrectly answered cards, which is designated on the board with a symbolic representation of a sad face in the preferred embodiment. When a player's draw pile is exhausted, all the previously incorrectly answered cards are shuffled to form a replacement draw pile.

In one embodiment, the track has at least one space that allows a player to continue drawing cards from the player's card set until the player gives an incorrect response or until the player has given a correct response to every card in the card set. In another embodiment, a special card is included in each card set which, when drawn, allows a player to continue drawing cards from the player's card set until the player gives an incorrect response or until the player has given a correct response to every card in the card set.

When a player has given correct responses to all cards in the player's card set and has placed any series cards in the proper sequence, one of the following may happen depending on the embodiment: a) the game is over for that player, and the first player to go through the card set in this manner is designated the winner; or b) the player receives a previously determined reward and may continue play with the same or another card set. In the embodiment wherein a player receives a previously determined reward after giving correct responses to all cards in the player's card set, the players create a goodie box prior to game play with rewards that appeal to the players. Upon giving correct responses to all cards in a player's card set, the player is allowed to choose a first reward from the goodie box.

In another embodiment, each player's card set contains at least one treat card. During game play, when a player has drawn all the treat cards from the player's card set, the player receives a second reward from a treat board. In some embodiments, the treat board may include a plurality of locations where a plurality of second rewards may be placed, with the particular second reward given to the player being determined randomly. In the preferred embodiment, the treat board has six pockets, numbered from one to six, with a second reward placed in each pocket. As an alternative to placing the actual second reward on the treat board, a second reward card indicating the second reward to be received may be placed on the treat board. The player to receive a second reward from the treat board rolls a die and collects the second reward from the correspondingly numbered pocket. The second reward may be comprised of anything the players would find desirable, including but not limited to food (sweets or fruit, for example), the right to enjoy a particular privilege or activity (a trip to a favorite place or to not perform an otherwise regular household chore, for example), or other items of value (money, gift certificates, or movie tickets, for example).

In the preferred embodiment, players would have the option to engage in “challenge play.” As the position token of a player electing to engage in “challenge play” passes the player's starting space during game play, the player takes a challenge token or challenge flag. At the conclusion of play, the player with the fewest challenge tokens or challenge flags out of all the players who elected to engage in “challenge play” is declared the winner of the challenge. The winner of the challenge may be entitled to receive a reward as determined by the players prior to game play.

In another embodiment, the position tokens, the board containing the said track and the spaces, and the card sets are represented by computerized images displayed on a display device operatively attached to a computer, with the computer being guided by a set of instructions; and the random number generator is a routine selectively performed by the computer.

The preferred embodiment would include a game manual describing how the game is to be set up and played. The game manual's contents may contain some or all of the following:
Introduction—Imagine That is an educational board game designed for learning virtually anything and in a fun way. The game cards are the most important part of the game. Each card contains a problem that must be correctly solved. The problem can be anything imaginable, such as, word and letter recognition, mathematical equations, sentence structure, and etc. Each player uses a set of cards, either preprinted or created, that is specifically designed towards that player's individual skill level and educational goals. The crucial step is to setup the cards in a manner that gives players the ability to increase their knowledge in any desired subject or subjects. Making the cards adaptable to the player's changing skill level makes the game uniquely designed. Each player is in competition with themselves rather than with an opponent. A single player can play the game alone. Young children should have an adult supervising play to assure proper play and learning. If players are of though not limited to, equal or similar skill levels in multiplayer games then competition with other players would be a fun option (see game play options later in this manual).

Completing a game is done by correctly solving the problems shown on the entire set of the player's game cards. How easy, or difficult, that will be depends on which cards are used or how the cards are setup prior to game play. This makes the game useful for any age and for any subject. Parents and guardians will find the game useful as a family activity by picking a subject they are interested in learning about, use or create a set of cards for that subject, and play along with the children. Multiple subjects can be used in each set if desired. Even those with disabilities can benefit from the game. The game also gives parents and guardians of school aged children a great opportunity to interact with the child's educators to use or create a set of cards that will match the lessons currently being taught in the classroom. In every imaginable way there are no limits to where the game will take you. That is why the game is called Imagine That!

OBJECTIVE: Correctly answer the problem or problems shown on the face of each game card.

This is the basic concept of the game. How much you get out of the game depends on how much you put into it. The game can be played in a few easy steps.
1. Setup the cards.
2. Choose a starting point, playing piece, and special sticker spaces.
3. Roll die and move.
4. Land on star, pick up one card. Land on own special sticker pick up two cards.
5. Solve all problems on the entire set of cards correctly.
6. Start over with the same cards or with a new set of cards.

The many added guidelines and suggestions in this manual will help make the game more valuable and enjoyable to all who play.

SETUP—these are basic setup guidelines. Those who are unfamiliar with the game at first may also wish to refer to the more advanced guidelines and ideas located in the sections found later in this manual.
1. Determine who will be playing the game and assess their skill level.
2. Decide on the number of cards each player will use. Actual game play will help determine the most effective number of cards to use. See BASIC GAME PLAY SUGGESTION #5.
3. Any game cards that are blank, or partially blank, fill in the card face with a problem. The coating on the cards allows the problem to be wiped off so it can be adapted to the player's changing needs. See CREATING CUSTOM GAME CARDS section for suggestions.
4. Create treat cards and place them in the numbered pockets on the treat board. The treat board is used when both the bug and frog treat cards are drawn. Determine whether 1 or 2 sets of bug and frog treat cards will be used during game play. Each player will use the same number of sets. See TREAT BOARD TIPS section for treat board suggestions.
5. Make up a goodie box and fill it with rewards that appeal to the players in the game. The goodie box is used for rewarding the player for successfully getting through the cards.
6. Each player selects 4 special stickers and places them randomly on empty game board spaces. Hint: use stickers that can be easily removed yet flat so that the playing pieces will rest upright when landing on them.

### How to Play

Before actual game play begins be sure to setup the game per the instructions in the SETUP section and especially that a set of game cards has been created for each player. Refer to the “CREATING GAME CARDS” section later in this manual for helpful hints and ideas.
1. Pick a playing piece and starting point—Each player picks a playing piece and starting point. Near each starting point are three boxes drawn on the board. Of the three one box contains a happy face and one a sad face. Place the game cards in the remaining middle draw pile box.
2. Determine who starts—Each player rolls die. The player with the highest number will start first.
3. Moving the playing pieces—The starting player rolls the die and from their starting point moves their playing piece the number of spaces shown on the die in a counter-clockwise direction. When the starting player's turn has ended, the player to the left will go next, and so on.
4. Landing on spaces—(Note—there is no limit to the number of pieces landing on the same space nor can any player block the movement of any other player.)
   Land on a star—draw one card.
   Land on own special sticker—draw two cards.
   Land on an opponent's special sticker—go back two spaces.
   Land on an intersection—choose direction to travel (must continue counter-clockwise) unless otherwise noted on the game board.
5. Using the Cards
   Each card typically has a problem that must be solved by the player. If the problem is correctly solved the card is placed on the happy face box located on the board near the player's starting point. If the problem is not correctly solved the card is placed on the sad face box. When the draw pile box is emptied, return any cards from the sad face box to the draw pile box so that they can be replayed. Along the bottom edge of each card is a happy face and sad face image. Next to each image there are instructions to direct the player on how to proceed based on the answer given by the player.
   Drawing the ZOOM card will allow the player to attempt to go through the cards in the draw pile without stopping as long as the problems are solved correctly. One important feature of the ZOOM card is that it helps determine the level the player understands. If the player struggles through ZOOM play then that means the problems are too difficult and should be simplified. On the other hand, if the player easily solves the problems, then moving to a more difficult level is in order. During ZOOM play the happy and sad face movement directions at the bottom edge of the cards are ignored (unless the card is needed for completing a combination move, for example, a KEEP IT card is drawn). ZOOM play continues until the problems on all cards in both the draw and sad face boxes are correctly solved, or until there is an incorrect response to a problem, which ever comes first. In the event of an incorrect response the player's turn is over and the game resumes as normal. The ZOOM card can be reinserted into the draw pile if desired.
   Drawing both the frog and bug treat card lets the player go to the treat board. The player rolls the die and removes the treat card or item from the treat board pocket matching the number on the die. This can take place as a set is drawn, at the end of the game, or at any time agreed upon by the players. A treat is given for each set of bug/frog treat cards drawn. See the TREAT BOARD TIPS section for treat board suggestions.
6. Completing a Game

When a player correctly solves the problems on all cards in the set, including the cards requiring combination moves, the game is over for that player. The player can then collect a reward from the goodie box, or such reward as was determined before game play began. Any remaining players continue play until they complete their own set of game cards. Players who have completed the game can start a new game, even while others are still playing. The player can either use the same cards if there is a desire or need to become more familiar with the problems, or a new set of cards can be created, or a combination of both.

### Basic Game Play Suggestions

1. Use different colored playing cards for each player. Color does not indicate skill level, only identification.
2. Instead of using treat cards in the treat board pockets use things like money, movie tickets, gift certificates, and etc. If using money, for example, an additional learning tool would be to have the player identify the currency and the total amount.
3. Create “KEEP IT” cards for things like complete sentences or putting the ABC's in order. The “KEEP IT” cards can also be used to learn how to put numbers in order. See CREATING GAME CARDS for ideas on creating “KEEP IT” cards.
4. A very good tool to use when creating game cards for school aged children are the homework assignments and lessons brought home from school. Also the progress reports sent home from the child's teacher are useful.
5. For children and teenagers in school, create cards using information that will help them for upcoming tests. This method can be used for college and vocational students as well.
6. Because of the game's design not all players will finish the game at the same time. While it is not necessary for players to finish the game at the same time, more sensitive players may feel pressured if other players finish before they do. Try reducing the number of cards in the set to speed up game play for a player that might be struggling to solve the problems. Increase the number of cards in the set if the player solves the problems too fast, though in this case more difficult cards would be a better alternative.
7. Use helpful tools like a calculator or a dictionary until the player has a better understanding of the problems.
8. When a player has successfully completed his or her set of cards and before creating more complicated cards try the same set again and use a timer to see if the player can solve the problems at a faster rate. This repetition should help the player retain the solutions to memory much longer.

### F.A.Q.

1. Q. What if nobody knows the correct answer to the problem? A. It is important during setup to insure a method is in place, for example a crib sheet, to have the correct answers readily available. Some research may be required. If a problem does exist during game play where the correct answer is not known the card will need to be set aside or play suspended for that player until the correct answer is found. Preprinted card sets can be ordered with an answer sheet where applicable.
2. Q. Can players move in any direction on the board? A. Players can move in any direction however, there is no benefit to moving in a direction different than counter-clockwise. Movement on the board is secondary to learning the cards. The game is designed to simplify continued play should the game not be completed in one sitting. If play is suspended it is not necessary to keep track of the players positions on the board until play resumes. The cards however should be kept in the order they were when play was stopped. The board and playing pieces can be stored without being kept in order. When play resumes the players simply start again at their starting spaces. The cards can be placed back on the board where they were when play ended. The exception would be during a Challenge match (see OPTIONS for Challenge Play information). In this case the position of the players will need to be noted for when play resumes.
3. Q. Why are there two ways to reward players (treat board and goodie box)? A. The game can take a while to complete depending on the setup, how often the game is stopped, the number of players, and etc. Waiting a long time to get the reward from the goodie box at the end of a player's game can be discouraging. The Treat Board was designed to fill that time gap, giving the players a bonus reward or rewards, thus giving the game an extra bit of enjoyment. Use two sets of frog/bug treat cards when there are situations where the game may take longer to play, i.e. 4 or more players.
4. Q. What if I want to simplify the game, do I have to follow all of the rules? A. The game is designed to assist players in learning. The game was also designed to be adaptable. Each game can be adjusted in any way based on the needs of the player or group of players. Nothing is written in stone. The simplest way to play would be to use just the cards. Hold them in your hand and use them like flash cards. Use your imagination to make the game play any way you wish.
5. Q. During game play players who are waiting for their turn run around, say the answer for the player whose turn it is, or are just being distracting. Can anything be done to help stop this? A. Try having a side activity, like a craft project or some drawing books available for those players who can't seem to sit still or be quiet. Some problems may require complex work to solve so if a player needs extra time to solve the problem on a card have the next player take their turn, as long as the player is not involved in a challenge match with the player needing extra time. Come up with penalties for players who are distracting or who answer for other players. Maybe they should lose a turn or go back a few spaces or even put a solved card or two back in the draw pile.
6. Q. I really don't want to spend time making up cards. Can I order cards with problems already made up? A. Yes, we are developing and compiling an extensive catalog of preprinted cards. Our development team will continue to add more preprinted cards to the catalog. We are also planning to develop a website where game owners can share and exchange cards they no longer need with other owners that can use them. This will help to both reduce costs and reduce waste. Information about our card recycling program will be posted on the game's website, www.imaginethatgame.com, as soon as it is available.
   Challenge Play—If players wish to make the game competitive, a challenge match can be issued. The goal for winning a challenge match is to finish the game in the fewest full revolutions around the game board. For those players participating in the challenge the general rules of the game remain the same.

### Challenge Play Instructions:

1. Any player, or players, wishing to issue a challenge must do so before game play begins. Players' accepting the challenge must also do so before game play begins. There must be 2 or more players participating in the challenge match.
2. Each player places the red challenge card near their starting point indicating they are in the challenge match. A supply of blue flags is placed on the board near the participating players. Flag colors can be different for player identification if desired.
3. The game proceeds as normal. However, as each player participating in the challenge match crosses their own starting space as they move around the board they pick up 1 blue challenge flag. The player must pick up the flag before the next player rolls the die.
4. If a challenge player catches another challenge player not picking up a blue flag after crossing the starting point AND after the next player rolls the die, a challenge card is tossed on to the board. The player caught must draw 2 blue flags. As a bonus the player, or players, who catch the offending player may draw and play a playing card from their draw pile before play resumes. However, if a player does not pick up a blue flag after crossing their starting point AND no other players see the mistake before the next player moves their playing piece after rolling the die then no blue flags for that player need to be drawn for that turn. This means that all challenge match players need to be conscientious of each others location at all times.
5. When any challenge match player completes the game all challenge match players count their flags. As long as any player still has a mathematical chance to win or tie, challenge play continues. The reward for winning the challenge can be as simple as the honor of having won, an extra trip to the goodie box or treat board, or it can be as rewarding as you want.

### Creating Game Cards

While there are many preprinted cards available and more being generated continually, game owners may wish to create custom playing cards. The following section will give many ideas on how to create custom playing cards. The ideas shown here are just a few of the limitless possibilities that can be used.

Creating the game cards is the most important step. A properly designed card gives the player the best possible chance to learn. The uppermost statement section of each card generally asks a question. The middle problem section of the card contains the problem that the player must solve. The bottom result section has the happy and sad face symbols that instruct the player on what to do based on the answer. Normally, the happy face rewards the player with movement on the board or positive words of praise. Usually the sad face instructs the player to put the card back into the sad face box on the board, but it can also direct movement on the board and words of encouragement.

It must first be determined what goals the player has for the specific set of cards to be created. For example, a kindergartener will likely be learning the ABC's and numbers. A card with the question “What letter is this?” or “What number is this?” would be written in the statement section of each card. A letter or number is written in the middle problem section for the player to identify. An important feature of the cards is that the coating allows the problems to be erased and adapted to the player's changing skills or goals. As the player becomes proficient with the problem, the letters and numbers can be erased and replaced with more complicated problems while leaving the question the same. This process is also used to change the question and the happy/sad face instructions when needed.

Below are basic suggestions for creating cards. There are no limits to the challenges that can be placed on the cards. Use your imagination to take learning as far as you wish to go.
1. Word cards. Place “What word is this?” in the statement section at the top of the card. Place a word in the middle problem section. Useful for any age.
2. Number cards. Place “What number is this?” in the question section at the top of the card. Place a number in the middle problem section. Useful for children thru kindergarten.
3. Letter cards. Place “What letter is this?” in the statement section at the top of the card. Place a letter in the middle problem section. To make the card more useful have the player make sounds the letter makes and say some of the words that start with the letter. Useful for young children.
4. Math cards. Place “What is the solution?” in the statement section at the top of the card. Place a math problem in the middle problem section. Useful for any age.
5. Shapes. Place “What shape is this?” in the statement section at the top of the card. Draw any shape like a diamond, triangle, rectangle, house, or etc., in the middle problem section for the player to identify. Useful for young children though more complex shapes can be used for any age.
6. Time cards. Place “What time is it?” in the statement section at the top of the card. Draw a clock face and hands in the middle problem section. Change the hands to help the player learn how to tell time. A digital clock face can be substituted or used in conjunction with the analog face. Useful for young children.
7. Money cards. Place “What are these?” in the statement section at the top of the card. Using images of currency, place them in the middle problem section. An option would be to place the currency images in a way to have the player add up what the value of the money is. Change the quantity of each item to make the card even more versatile. Useful for any age.
8. “KEEP IT” cards. Creating these cards enhances the player's learning. These cards are played as normal by solving the problem. However, the happy face instruction will read “KEEP IT”. Once the problem is solved the card is placed off the board and kept there until all cards in the player's set are correctly solved. The KEEP IT cards are then collected and assembled in the order required before game play ends. For multiple sets of KEEP IT card problems, place a matching symbol on each card face of each set (see FIG. 4), use stickers that can be removed if needed. Some examples of KEEP IT card sets are:

a. Sentences. Using “WHAT WORD IS THIS?” cards make up a sentence with one card per word (i.e. four KEEP IT cards for the sentence “MY SOCKS ARE WHITE”). For multiple sentences place a symbol on the card for each word in the sentence. Use a different symbol for each sentence.

b. ABC's. Using “WHAT LETTER IS THIS?” cards place a letter on each card to be placed in order. It is not necessary to use the entire alphabet at one time. Break up the alphabet in to sections. This will keep the total number of cards down which will help speed up the game. Try skipping letters to (for example use A, H, M, R, and U only) to make this more challenging.

c. Numbers. Using “WHAT NUMBER IS THIS?” cards place a number on each card to be placed in order. Try skipping numbers by using only even or odd numbers, or every five or ten numbers.

d. Make puzzle “KEEP IT” cards by drawing or pasting an image on paper then cutting it up into card sized pieces. The player collects and saves the cards as they are picked from the draw pile. When the player's complete set of cards have been solved the player takes the puzzle cards and lays them out in the correct order.

e. Word definition. Using “WHAT WORD IS THIS?” cards place a word on each card in a predetermined number of cards. Create a list of definitions for each word on a separate piece of paper. As the cards are drawn the player will need to first say the word and then choose the matching definition from the list. Optional, instead of a list on a piece of paper, “KEEP IT” cards can be created that define the word. The player then needs to match the definition card to the word it defines.
9. Happy/Sad Faces. While these faces are generally used to instruct the player where to place the cards based on the answer given they can also be used for learning and for fun. For younger children have the happy face instruction locate a part of their body like their left hand or right ear. Have them jump up and down or stand on one foot. Give a parent or grandparent a hug could be another option. Words of praise would also apply. In addition to putting the card back the sad face instructions could be something like make your bed or take out the trash. Words of encouragement could also be used for the sad face instructions.
10. Movement cards. Instead of problems the cards can also give the player movement instructions. For example, it can be written to have the player roll the die and move that many spaces. Also, movement to the next, star, intersection, or player's special sticker can be written on the card.
11. Foreign language cards. Use the cards to increase foreign language skills, including sign language.
12. Attitude adjustment cards. Face it, some children have trouble sitting still or keeping quiet when playing with others. Try creating cards to help teach them that acting certain ways is not okay. Multiple choice cards are a good option. Have a card ask what a player does when it is not their turn. The choice of answers could be, run around, make loud noises, bother other players, and sit quietly. Another card could ask what a player does if they don't solve the problem correctly. The choice of answers could be, pout, whine, throw a fit, and try harder next time.

### Treat Board Tips

The Treat Board was devised as a bonus for the players. Most children find it exciting to get special treats while in the middle of projects and activities. That is the main reason the Treat Board was created. The design of the Treat Board allows it to be rewarding for players of any age too. A little imagination and creativity will produce a board that will be enjoyed by all.

Using the treat board can be as easy or as complicated as desired. Situations, like varied age groups, can create unique challenges when creating the treat board. Finding the ‘right treat’ for all players with different tastes will be complicated. Using the treat board may result in ‘luck of the draw’ situations where a player may receive something not necessarily considered a treat.

The only rule for using the treat board is that when the player draws both a bug treat card AND a frog treat card that player then rolls the die and removes the item from the pocket whose number corresponds to the number rolled on the die. A blank card is used for treat board cards. Write what the treat is on the card and place it in one of the numbered treat board pockets.
Simple items like, a cookie, piece of candy, or favorite fruit treat, can be written on the treat board cards.
Other items that could be written on the treat board cards are: skip one chore, a trip to a favorite place, or pick a computer game to rent or buy.
The treat board card could instruct the player choose a favorite meal.
Instead of using treat board cards for the treat board pockets use things like money, movie tickets, gift certificates, and etc. If using money, for example, an additional learning tool would be to have the player identify the currency and the total amount.

### Glossary

Goodie Box—a container used to store rewards for a player to draw from once the set of cards played have been successfully completed.
Happy Face—a symbol used to represent a positive response or a correct answer.
Keep It—a card directing the player to retain the card until the draw pile is exhausted and then matched to another card, or cards, to complete a series of words, phrases, or other combinations.
Sad Face—a symbol used to represent a negative response or an incorrect answer.
Treat Board—a board with 6 numbered spaces or slots to store rewards for drawing the frog and bug treat cards.
Zoom—a card directing the player to continue drawing cards as long as the player provides the correct answer until the draw pile is exhausted. An incorrect answer ends zoom play and the player continues the game as normal.

The above summary of the present invention is not intended to represent each embodiment, or every aspect, of the present invention. Additional features and benefits of the present invention are apparent from the detailed description and figures set forth below.

### BRIEF DESCRIPTION OF THE FIGURES

FIG. 1 is a top view of the game board.

FIG. 2 is a pictorial representation of a position token and a die to be used during game play.

FIGS. 3-4 are a view of the back side of various cards that may be in a player's card set.

FIG. 5 is a front view of the treat board.

FIG. 6 is a view of the back side of the treat cards and of the zoom card.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as described.

### DETAILED DESCRIPTION OF THE ILLUSTRATED EMBODIMENTS

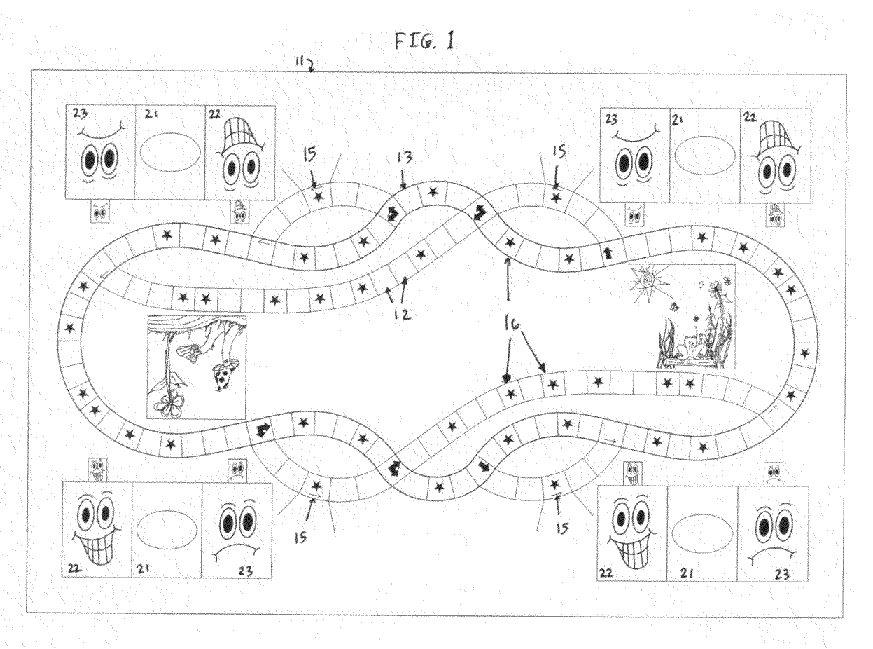

Referring to FIG. 1, there is shown a top view of the game board (11) used in the educational board game described herein. The game board (11) includes a plurality of playing spaces (12) along a track (13). At least one of the spaces is designated as a starting space (15). At least one space is designated as a draw space (16).

As also depicted in FIG. 1, the game board (11) has a designated location where each player's card set is placed to form a draw pile (21), a designated location where each player discards the cards to which a correct response was given (22), and a designated location where each player discards the cards to which an incorrect response was given (23). Other game board layouts besides that depicted in FIG. 1 could be made.

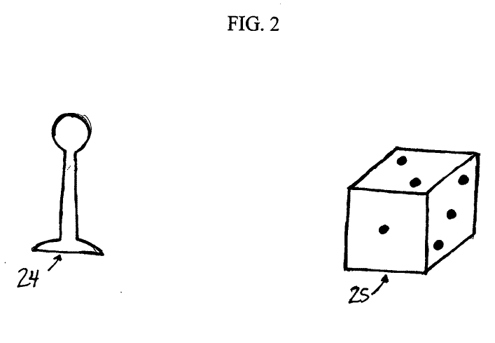

Referring to FIG. 2, a position token (24) is shown, which will be placed on the game board (11) and moved along the track (13) depicted in FIG. 1. The number of spaces the token (24) is moved on a player's turn is determined by rolling a die (25).

Play begins with each player placing a position token (24) on a starting space (15). On a player's turn, the player rolls the die (25) and moves his or her token (24) along the track (13) the number of spaces indicated on the die. When a player's token ends its move on a space designated as a draw space (16), the player is instructed to draw a card from the player's card set.

When a player draws a card from his card set, the player attempts to give the correct response. When the correct response is given, the player follows instructions as indicated on the card, which may include placing the card in the location designated for placement of correctly answered cards (22). When an incorrect response is given, the player places the card in the location designated for placement of incorrectly answered cards (23). When a player's draw pile (21) is empty, the incorrectly answered cards are taken from their pile (23) and reshuffled to form a new draw pile. When a player has correctly answered all cards in the player's card set, the player is either designated the winner or receives a previously determined reward from a goodie box.

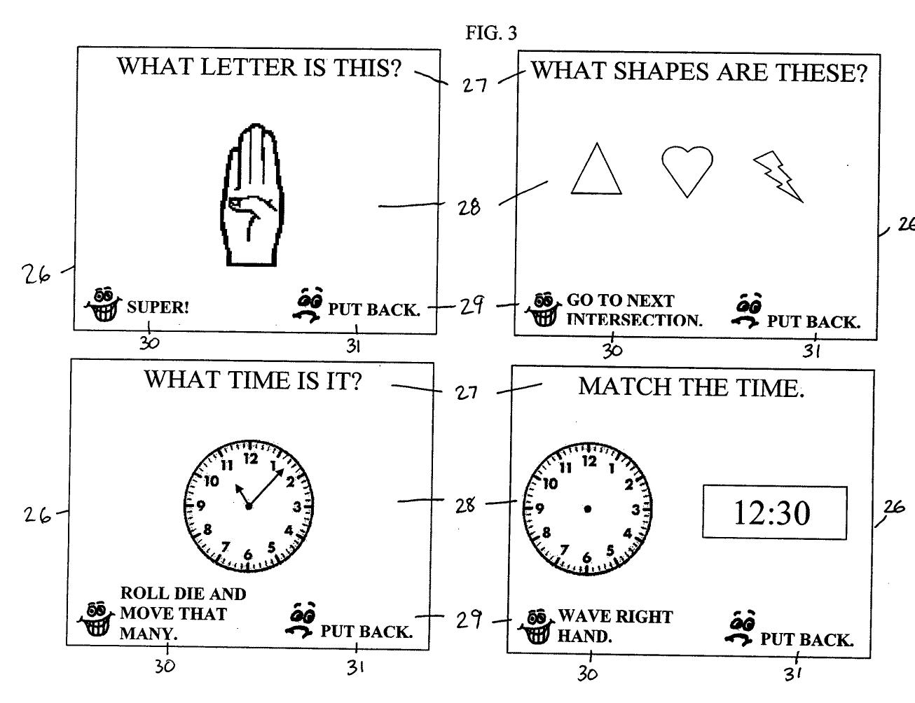

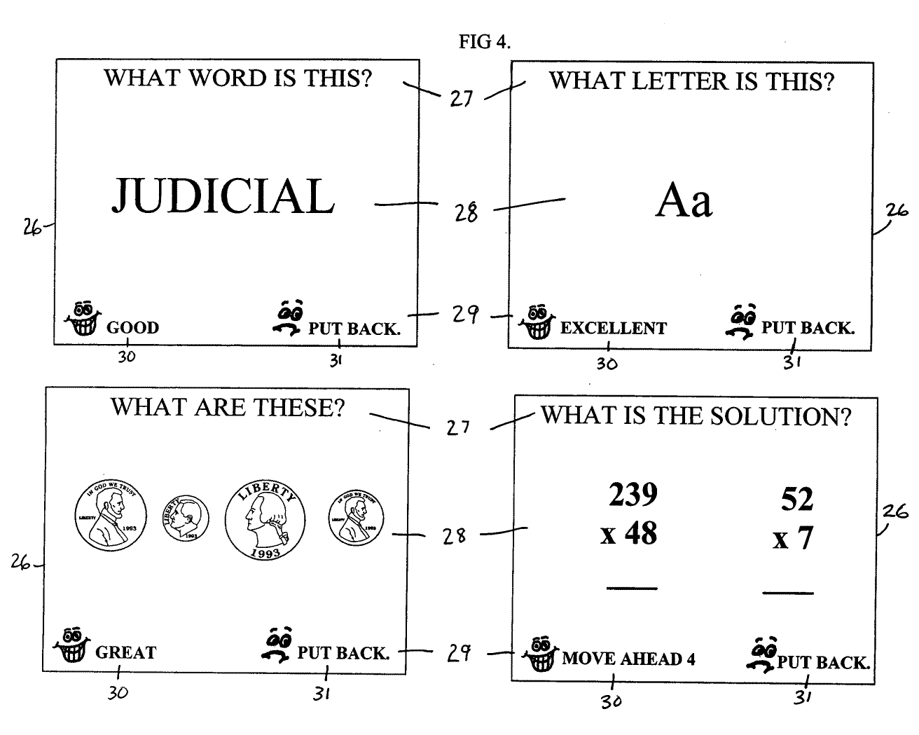

Referring to FIGS. 3 and 4, examples of the back side of cards (26) that may be in a player's card set are shown. Each card (26) has a top section (27) containing a question or task designed to test the player's knowledge and a bottom section (29) containing instructions to the player. The bottom section (29) is divided into two portions, a first portion (30) instructing the player what is to be done if the correct response is given and a second portion (31) instructing the player what is to be done if an incorrect response is given.

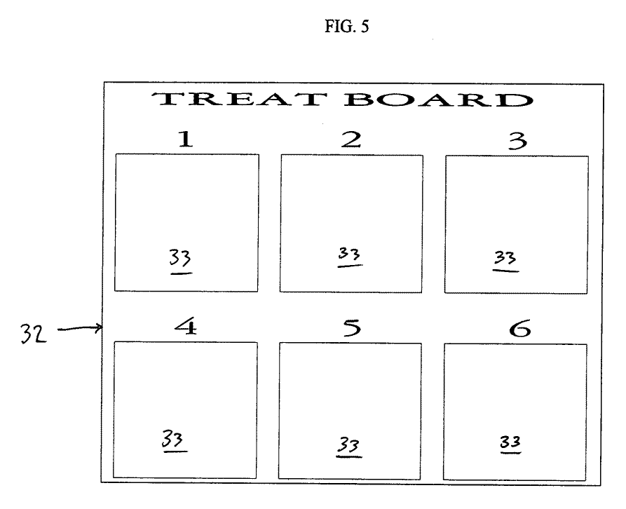

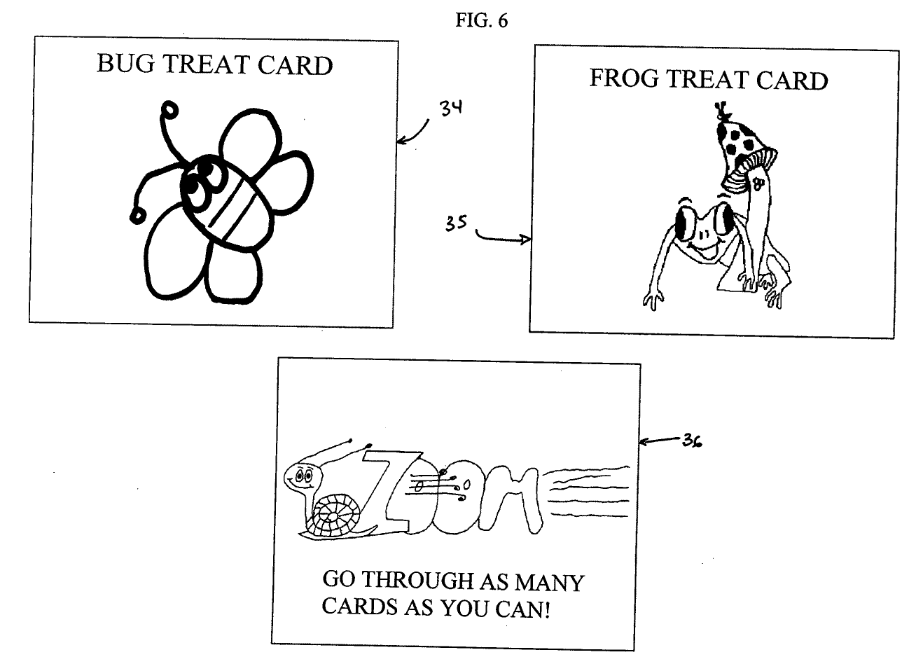

Referring to FIGS. 5 and 6, a treat board (32) is shown, with numbered pockets (33) where rewards may be placed. A first treat card (34) and a second treat card (35) are also shown, which are included in each player's card set. When a player draws all the treat cards (34, 35) in his or her card set, the player rolls a die (25) and receives the treat from the corresponding pocket (33) on the treat board (32). The number of treat cards (34, 35) in each player's card set may be increased as determined by the players prior to beginning play.

Also referring to FIG. 6, a zoom card (36) is shown. When a player draws a zoom card, the player is allowed to continue drawing cards from the player's card set until the player gives an incorrect response or until the player has given a correct response to every card in the card set. The number of zoom cards (36) in a player's card set may vary as determined by the players prior to beginning play.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as described.

I claim:

1. An educational board game comprising:
a plurality of position tokens, each corresponding to a player of said game;
a board depicting a track with a plurality of spaces, each of said spaces being sized to accept at least one of the position tokens;
a card set corresponding to each player of the game, each card set comprising a plurality of cards, a back side of each card having a top portion and a bottom portion, the top portion containing a question or task designed to test the player's knowledge, and the bottom portion containing a first set instructions to the player to be followed if the player correctly responds to the question or performs the task and a second set of instructions to the player to be followed if the player incorrectly responds to the question or performs the task;
each card set being characterized by a quantity of cards, a difficulty level, and a subject matter, the card set of one player differing from the card set of another player in at least one of the quantity of cards, the difficulty level, and the subject matter
at least one of said spaces on the track being designated as a starting space, and at least one of said spaces being designated as a draw space requiring a player to draw one or more cards from that player's corresponding card set and to attempt to provide the correct response to the question or task on each card taken; and
a random number generator for regulating motion of the position tokens along the track.

2. The educational board game of claim 1 in which at least one card set is further comprised of at least one series subset, each series subset comprising a plurality of series cards, a back side of each series card having a series symbol unique to the series subset, a top portion, and a bottom portion, the top portion containing a question or task designed to test the player's knowledge, and the bottom portion containing a first set instructions to the player to be followed if the player correctly responds to the question or performs the task and a second set of instructions to the player to be followed if the player incorrectly responds to the question or performs the task, the first set of instructions directing the player to retain the series card, and in which the player is required to place the series cards of each series subset in a correct sequential order.

3. The educational board game of claim 1 in which the top portion of one or more cards is at least partially blank and has a surface that can be repeatedly written on and erased.

4. The educational board game of claim 1 in which the track has a starting space corresponding to each player.

5. The educational board game of claim 4 in which the track has at least one player-specific draw space for each player, said player-specific draw spaces requiring one player to draw one or more cards from that player's corresponding card set and to attempt to provide the correct response to the question or task on each card taken.

6. The educational board game of claim 5 in which said draw space or spaces are designated on the track by a removable draw sticker and said player-specific draw spaces are designated on the track by a removable special draw sticker unique to each player

7. The educational board game of claim 1 in which one of said players wins the game when said player has given a correct response to each card in said player's card set.

8. The educational board game of claim 2 in which one of said players wins the game when said player has given a correct response to each card in said player's card set and has placed the series cards of each series subset in a correct sequential order.

9. The educational board game of claim 1 in which the track has at least one space designated as a zoom space requiring the player to continue drawing cards from the player's card set until the player gives an incorrect response or until the player has given a correct response to every card in the card set.

10. The educational board game of claim 1 in which each card set has at least one card designated as a zoom card requiring the player to continue drawing cards from the player's card set until the player gives an incorrect response or until the player has given a correct response to every card in the card set.

11. The educational board game of claim 1 further comprising a goodie box containing a first reward to be given to a player after that player has provided a correct response to each card in the player's card set.

12. The educational board game of claim 1 in which each player's card set has at least one treat card and further comprising a treat board having a second reward to be given to a player after that player has drawn all the treat cards from that player's card set.

13. The educational board game of claim 1, further comprising a plurality of challenge tokens, one of which is given to a player as that player's position token passes the starting space corresponding to that player.

14. An educational board game comprising:
a plurality of position tokens, each corresponding to a player of said game;
a board depicting a track with a plurality of spaces, each of said spaces being sized to accept at least one of the position tokens;
a card set corresponding to each player of the game, each card set comprising a plurality of cards, a back side of each card having a top portion and a bottom portion, the top portion containing a question or task designed to test the player's knowledge, and the bottom portion containing a first set instructions to the player to be followed if the player correctly responds to the question or performs the task and a second set of instructions to the player to be followed if the player incorrectly responds to the question or performs the task;
each card set being characterized by a quantity of cards, a difficulty level, and a subject matter, the card set of one player differing from the card set of another player in at least one of the quantity of cards, the difficulty level, and the subject matter;
at least one card set being further comprised of at least one series subset, each series subset comprising a plurality of series cards, a back side of each series card having a series symbol unique to the series subset, a top portion, and a bottom portion, the top portion containing a question or task designed to test the player's knowledge, and the bottom portion containing a first set instructions to the player to be followed if the player correctly responds to the question or performs the task and a second set of instructions to the player to be followed if the player incorrectly responds to the question or performs the task, the first set of instructions directing the player to retain the series card, and in which the player is required to place the series cards of each series subset in a correct sequential order;
one of said spaces on the track being designated as a starting space, at least one of said spaces being designated as a draw space requiring a player to draw one or more cards from that player's corresponding card set and to attempt to provide the correct response to the question or task on each card taken, and at least one of said spaces being designated as a player-specific draw space for each player, said player-specific draw spaces requiring one player to draw one or more cards from that player's corresponding card set and to attempt to provide the correct response to the question or task on each card taken; and
a random number generator for regulating motion of the position tokens along the track.

15. The educational board game of claim 14 in which the track has at least one space designated as a zoom space requiring a player to continue drawing cards from the player's card set until the player gives an incorrect response or until the player has given a correct response to every card in the card set.

16. The educational board game of claim 14 in which each card set has at least one card designated as a zoom card requiring the player to continue drawing cards from the player's card set until the player gives an incorrect response or until the player has given a correct response to every card in the card set.

17. The educational board game of claim 14 in which the top portion of one or more cards is at least partially blank and has a surface that can be repeatedly written on and erased.

18. The educational board game of claim 14 in which one of said players wins the game when said player has given a correct response to each card in said player's card set and has placed the series cards of each series subset in a correct sequential order.

19. The educational board game of claim 14 in which said plurality of position tokens, said board with said track and said spaces, and said card sets are represented by computerized images displayed on a display device operatively attached to a computer, said computer being guided by a set of instructions; and said random number generator is a routine selectively performed by said computer.

20. A method of playing an educational board game, comprising the steps of: (a) providing a position token for each player of the game; (b) providing a game board depicting a track comprised of a plurality of spaces, each of said spaces being sized to accept at least one of the position tokens, with at least one of said spaces designated as a starting space and at least one of said spaces being designated as a draw space; (c) providing a unique card set for each player of the game, each card set comprising a plurality of cards, a back side of each card having a top portion and a bottom portion, the top portion containing a question or task designed to test the player's knowledge, the question or task on each card being selected prior to play according to an educational goal or need of the player, and the bottom portion containing a first set instructions to the player to be followed if the player correctly responds to the question or performs the task and a second set of instructions to the player to be followed if the player incorrectly responds to the question or performs the task; (d) moving one of said position tokens according to a random number generator and, when a player's position token lands on said designated draw space, drawing a card from the player's card set and attempting to give a correct response to the question or task thereon.
